(19) United States
(12) Patent Application Publication
(10) Pub. No.: US 2019/0384324 A1
(43) Pub. Date: Dec. 19, 2019

(54) COLLABORATIVE TRAVEL SYSTEMS FOR AND METHODS

(71) Applicant: Robert David Sager, Manhattan, KS (US)

(72) Inventor: Robert David Sager, Manhattan, KS (US)

(21) Appl. No.: 16/443,534

(22) Filed: Jun. 17, 2019

Related U.S. Application Data
(60) Provisional application No. 62/685,559, filed on Jun. 15, 2018.

(51) Int. Cl. G05D 1/02; G08G 1/00; G08G 1/087

(52) U.S. Cl. CPC G05D 1/0293; G05D 1/0297; G05D 2201/0213; G08G 1/22; G08G 1/087; G05D 1/0221

(57) ABSTRACT

A collaborative driving system and method is provided. The system includes independent sensors and computers on a plurality of vehicles and a means for each vehicle to communicate with a central system and/or with one or more other vehicle, thereby allowing such vehicles to travel together for one or more common segment of their respective travels. The method includes utilizing recorded and real-time information to enable the system to learn while providing real-time guidance to the vehicles and/or to a driver of the vehicles while updating and/or supplementing algorithms and other information associated with the system. The present invention revolutionizes the autonomous vehicle industry by evolving it into a constantly-learning network of drivers, vehicles, and systems. The system also includes a means of prioritizing one vehicle (such as emergency vehicles) over other vehicles and/or allowing individuals to pay a premium to obtain priority over other vehicles.

### CROSS-REFERENCE TO RELATED APPLICATIONS

This application claims priority pursuant to 35 U.S.C. 119(e) to co-pending U.S. Provisional Patent Application Ser. No. 62/685,559, filed Jun. 15, 2019 the entire disclosure of which is incorporated herein by reference.

### FIELD OF THE INVENTION

The present invention relates generally to vehicles and transportation technology. More specifically, the present invention is concerned with systems for and methods of coordinating travel for a plurality of vehicles.

### BACKGROUND OF THE INVENTION

Every day, millions of personal and corporate vehicles transport people and goods across thousands of highways and roadways all over the United States and the world. As a result, millions of people spend at least some time, and many spend a significant amount of time, behind a wheel during their day. While this time can be relaxing or otherwise enjoyable to some drivers at some times, it can be aggravating to other drivers at other times. Unfortunately, other forms of transportation, such as trains and buses, are not always available or practical. Carpooling can also be difficult or impractical to coordinate and ride services can be expensive. Consequently, many drivers desire personal autonomous vehicles so that they can be passengers, rather than drivers, in their own personal vehicles. Unfortunately, replacing drivers with autonomous vehicles is much more difficult than simply creating autonomous vehicles. For instance, training autonomous vehicles to properly respond to every potential scenario can be difficult and time consuming, during which time public perception of autonomous vehicles can be adversely affected, especially when an autonomous vehicle is involved in an accident that could have been avoided by an attentive driver. Consequently, it would be beneficial to have a collaborative driving system that is capable of serving as a stepping stone to complete vehicle autonomy.

For decades, since the invention of the automobile and even earlier, drivers of automobiles and similar vehicles (including boats, planes, and even to some extent animal-drawn vehicles), have relied on the experience and related comfort level of a driver to reduce risks and avoid accidents. Consequently, it would be beneficial to have an autonomous vehicle that utilizes experiential learning to reduce risks and accidents. It would further be beneficial if such autonomous vehicles were configured to identify circumstances outside of the systems experiences and/or to identify a relative comfort level associated with such circumstances.

While personal autonomous vehicles have made great advancements, sensors and computers on board current autonomous vehicles do not currently provide the same level of safety as does an attentive driver. Passengers, however, are rarely as attentive as a driver. Consequently, an autonomous vehicle with several “passengers” is generally less safe than is a vehicle with an attentive driver. For instance, an attentive driver is more likely to predict road conditions, actions of another vehicle, actions of a pedestrian, or actions of an animal, making it more likely that the driver will avoid an accident than an automated vehicle will, regardless of the number of passengers within the automated vehicle. Furthermore, some automated vehicles do not even have passengers, and passengers in automated vehicles may be asleep or otherwise unable to react at a critical time. Consequently, it would be beneficial to have a system and method for increasing safety of automated vehicles regardless of the number of passengers in the vehicle and regardless of the passenger's attentiveness and ability to react. It would further be beneficial if such system and method did not require building of additional infrastructure or significant alterations to existing infrastructure. It would also be beneficial to have a system for obtaining additional funds for upgrading infrastructure, such as through payment of a subscription fee and/or payment of a premium or other fee for obtaining priority and/or other privileges not otherwise afforded with today's systems. For instance, many infrastructure improvements have gone the route of developing HOV lanes in the hopes that it will increase carpooling, thereby decreasing overall traffic. Unfortunately, carpooling is not always practical or possible, but many individuals would pay a premium to travel on the HOV lanes. Accordingly, it would be beneficial to have a system that allows individuals to pay a premium to receive preferential treatment without risk of being pulled over and/or receiving a ticket.

Existing autonomous systems seek to avoid collisions, such as by controlling speed and following distances relative to a speed of a vehicle directly in front of the vehicle. Such vehicles are also often configured to sense and determine other conditions of adjacent vehicles, such as braking conditions, merging conditions, and the like. Unfortunately, such processes take time and can be somewhat unreliable, requiring such systems to increase spacing in order to avoid collisions. In this way, existing systems tend to aggravate traffic issues, such as by failing to optimize capacity on roadways. Furthermore, large spacing between vehicles often results in self-driven cars darting between lanes, which can increase risks of accidents and/or can cause autonomous cars to provide even larger spacing. As spacing becomes greater, roadway capacity optimization is further reduced and/or drivers become more likely to take control of the vehicle, thereby eliminating many (if not all) of the benefits associated with having automated vehicles. Accordingly, it would be beneficial to have a system for optimizing use of roadways, thereby alleviating traffic congestion. It would further be beneficial if the system encouraged users to maintain use of such systems, such as by maintaining comfortable proximity to adjacent vehicles while maintaining safe following distances.

Existing autonomous vehicles also fail to account for transportation of materials, such as volatile chemicals or the like, transportation of materials in general, transportation of energy, or the like. Accordingly, it would be beneficial to have a system that accounts for a variety of transportation types while reducing risks associated with transportation of various items/sub stances/etc.

### SUMMARY OF THE INVENTION

The present invention comprises systems for and methods of facilitating safe and efficient autonomous travel through collaborative travel. In addition to providing a superior automated vehicle experience, the present system is capable of serving as a stepping stone for realizing even more advancement in vehicle autonomy.

The present invention is capable of utilizing experiential learning to reduce risks and accidents. In some embodiments, the present invention is configured to identify circumstances outside of the system's experiences and/or is configured to identify a relative comfort level associated with such circumstances.

The present invention increases safety of automated vehicles regardless of the number of passengers in the vehicle and regardless of the passenger's attentiveness and ability to react, all without the requirement to build and/or alter infrastructure. Furthermore, the present invention optimizes capacity of existing infrastructure while maintaining and/or increasing safety of vehicles all while encouraging users to continue use of the system. Furthermore, the present invention provides innovative means of improving infrastructure and/or for promoting government or corporate involvement into improving the same. Furthermore still, the present invention accounts for a variety of transportation types while reducing risks associated with transportation of various items, substances, and the like.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention comprises systems for and methods of facilitating safe and efficient autonomous travel through collaborative travel. In some embodiments, the present invention includes a system for and a method of allowing a first vehicle to communicate with one or more other vehicle, such as a second vehicle, a third vehicle, or the like. In some embodiments, the invention includes a system for and a method of allowing a plurality of vehicles to communicate with a central system and/or to allow a central system to communicate with a plurality of vehicles.

In some embodiments, communication between vehicles allows each vehicle to know what the other vehicle is doing or will be doing. In some embodiments, each vehicle also obtains sensor information from the other vehicle, thereby increasing predictability and sufficient notice of potential concerns with road conditions, other drivers, pedestrians, animals, or the like. In some embodiments, the system includes a means of allowing a driver or passenger of a first vehicle to communicate, either directly or indirectly, with a driver of a second vehicle, or with the second vehicle itself, thereby eliminating or otherwise reducing the need for the second vehicle to predict actions of the driver of the first vehicle and/or to provide the second vehicle with information pertaining to preferences of the driver of the first vehicle (i.e., whether the driver of the first vehicle would like the second vehicle to speed up, slow down, move over, pull over, exit, not follow so closely, merge, provide room for merging, or the like).

In some embodiments, a first vehicle communicates information to one or more other vehicle, such as speed, acceleration, destination, intended route, preferred speed, fuel requirements, braking capabilities, acceleration capabilities, weight, cargo (including, but not necessarily limited to, any volatile substances and/or substances that may become volatile when mixed with other substances, such as substances associated with cargo of another vehicle), and the like. In some embodiments, the system compares information from two vehicles and pairs such vehicles together for one or more segment of their respective travels. In some embodiments, the system determines speed of each vehicle and spacing between the vehicles based on a variety of information, including road conditions, vehicle condition (i.e. tire and brake condition), vehicle capabilities (i.e. acceleration capability, braking capability, steering capability, and general vehicle and/or driver responsiveness), driver preference, or the like. In some embodiments, the system is configured to optimize roadway capacity, such as by linking a plurality of vehicles together, thereby creating a virtual train.

In some embodiments, the system (i.e. a central system, a local system, a sub-system, an individual vehicle system, or the like) is configured to cause a plurality of vehicles to travel together as a virtual train for one or more segment of their respective travels. In some embodiments, the system directs one or more vehicle to link to one or more other vehicle. In some embodiments, the system causes one or more vehicle to go a first speed for a first period of time and/or to take a certain route so as to meet up with one or more other vehicle at a certain time and/or place, thereby allowing the vehicles to collaborate while each travels along one or more segment of their respective travels. In some embodiments, the system is configured to cause one or more vehicle in a virtual train to increase spacing so as to allow an additional vehicle to join the virtual train and/or to reduce spacing after a vehicle has left the virtual train. In some embodiments, each vehicle in a train is configured to accommodate adding and removing vehicles from the virtual train and/or is configured to enter and exit one or more virtual train while causing the least amount of disruptions to such trains and to vehicles in such trains.

In some embodiments, a driver of a vehicle and/or the vehicle itself is provided with information about a virtual train and/or information pertaining to one or more vehicle or driver associated with such virtual train prior to such vehicle joining the virtual train. In some embodiments, the system enables a driver of a vehicle, or the vehicle itself, to indicate to other vehicles of the virtual train that such vehicle will be exiting the virtual train and/or allows such driver or vehicle to indicate a desire to make a change to the virtual train, such as a change in spacing, speed, route, or the like. In some embodiments, a requested change is based on information obtained from a driver and/or vehicle associated with road conditions, weather conditions, hazards, or the like. In some embodiments, the system enables other drivers and/or vehicles associated with the virtual train to elect whether to accept a requested change and/or whether to propose a compromise change.

In some embodiments, the system is configured to assess risks and objectives based on information received from sensors, drivers, passengers, vehicles, a central system, or other information sources and determines, suggests, and/or implements one or more change based on such information. In some such embodiments, the system records consequences associated with changes (or lack of changes) and associates such consequences with factors associated with decisions leading to such consequences, thereby enabling the system to use such information to better determine how to handle similar situations in the future. In some embodiments, the system is configured to learn by recording human reactions and/or recording consequences associated with human reactions. In some embodiments, the system is configured to provide an indication to a driver and/or passenger of a vehicle, such as a vehicle within a virtual train, that one or more condition is outside of the systems experiential knowledge and/or comfort level. In some embodiments, the system is configured to provide an indication to one or more user, such as a user of a central control system, a passenger of a vehicle, a driver of a vehicle, or the like, that the system is in a learning mode. In some such embodiments, the system learns by recording actions of one or more driver of a vehicle, such as a lead vehicle in a virtual train. In some such embodiments, the system obtains information associated with the driver's driving record, experience level, comfort level, or the like. In some such embodiments, each vehicle in a virtual train is provided with information associated with the system being in a learning mode, thereby allowing drivers of such virtual train to assess whether they would prefer to stay in the virtual train, either as a designated driver or as a following passenger, or whether such driver would prefer to exit the virtual train.

In some embodiments, one or more vehicle in a virtual train provides an indication to one or more driver in the vehicle that they must be attentive to one or more condition or circumstance, such as when such condition or circumstance is outside of the systems experience or comfort level. In some embodiments, the system includes a feature for determining how many passengers and/or drivers in each vehicle are being attentive and to what they are being attentive to, such as by determining whether a person's eyes are open, whether the person's eyes are focused outside of the vehicle (and in which direction) and/or whether the person's eyes are focused inside the vehicle. In some embodiments, the system is configured to record attentiveness of each driver, circumstances and reactions associated therewith, and consequences following such reactions (or lack of reactions), thereby allowing the system to increase its experience and comfort level.

In some embodiments, a central system is configured to calculate best routes and/or to communicate hazards for one or more vehicle (such as weather hazards, construction hazards, emergency situations, terrorist activities, war, or the like), thereby allowing a driver and/or passenger of such vehicle to determine whether to go a different route than originally intended. In other embodiments, the central system prevents or otherwise inhibits a driver from directing a vehicle to travel along a route, such as when a hazard (i.e. an accident, construction, congestion, or the like) is associated with such route. In some embodiments, the central system is configured to direct vehicles along a route to speed up, slow down, move over, turn around, or the like, such as to provide easier access for emergency vehicles or the like. In some embodiments, the central system is configured to obtain information from a plurality of vehicles, such as road conditions, hazards, driving behaviors, or the like. In some embodiments, the central system is configured to communication information to a plurality of vehicles, thereby providing such vehicles, and/or passengers and/or drivers of such vehicles, with advanced notice of road conditions, hazards, driving behaviors of other vehicles in the area, or the like. In some embodiments, the central system is configured to communication information to a central authority, such as road maintenance teams, animal control teams, highway patrols, local police, or the like. In some embodiments, the system is configured to provide temporary priority to one or more class of vehicles, such as a government vehicles, emergency vehicles, personal or corporate vehicles who pay extra for the benefit of obtaining temporary priority (such as if the individual is running late to a meeting, is rushing someone to the hospital, or the like). In this way, individuals can choose whether to pay for additional privileges up-front rather than risk paying a fine, such as by improperly driving in an HOV lane or the like, associated with improper use of existing infrastructure.

In some embodiments, the system is configured to calculate risks and assess potential casualties. In some embodiments, the system is configured with demographic information associated with each passenger within a vehicle and safety features associated with such vehicles. In some embodiments, the system includes positional information for each passenger within a vehicle and additional information for assisting the system with determining the most socially acceptable risks associated with a potential crash. For instance, in some embodiments and under some circumstances, the system is configured to allow a first vehicle containing a single adult passenger to sustain more damage in such accident than a second vehicle containing an infant child due to the correlating risks being much higher for an infant than for an adult. In some embodiments, the system is able to prevent casualties by coordinating damage to vehicles and/or otherwise coordinating reactions of numerous vehicles during a potential accident event. In some embodiments, the system is configured to provide triage information to one or more first responder based on passenger demographic and position information and/or based on impact or other information obtained from a vehicle. In some embodiments, the system is configured to reduce risks of harm and/or damage, such as by directing vehicles to change position within a virtual train. In some embodiments, the system is configured to direct larger vehicles with slower response/braking times to move toward a front portion of a virtual train and/or is configured to direct smaller vehicles with quicker response/braking times to move toward a rear portion of a virtual train. In some embodiments, the system is configured to determine whether a certain vehicle can and/or should join a virtual train, such as due to the vehicle's cargo and/or passenger manifest. In some embodiments, one or more vehicle is directed to move closer to or away from one or more other vehicle in a virtual based on such vehicles cargo and/or manifest. In some such embodiments, the position of one or more vehicle is dependent on the cargo and/or manifest of one or more other vehicle.

The present invention is configured to work with existing vehicles and infrastructures, thereby expediting the implementation and integration of the various systems and methods of the present invention. In some embodiments, the system is configured to interface with existing systems and vehicles and/or existing systems and vehicles can be upgraded to integrate with the present invention, such as by adding sensors and/or control devices to such systems and/or computers. In some embodiments, the system obtains information from a first group of vehicles with dedicated drivers (such as hired professional drivers, drivers who receive discounted or free service , drivers whose vehicles are equipped with sensors but not control devices, or other drivers) and passes such information on to another group of vehicles (such as vehicles with inexperienced drivers, tired drivers, distracted drivers, or vehicles with no driver at all), thereby allowing the system to navigate or otherwise safely control the vehicles of the second group of vehicles and/or to otherwise assist in the safe movement of such vehicles.

In some methods of the present invention, a first driver of a first vehicle is capable of taking a nap and/or otherwise being distracted from driving (i.e. researching, writing, watching a movie, or the like) while the system watches for hazards based on information it obtains from sensors on the vehicle and information it receives from outside of the vehicle, such as from sensors and/or drivers of other vehicles and/or from another information source. In some methods, the system provides the driver of the first vehicle with an indication that one or more condition or circumstance is outside of the system's realm of experience and/or comfort level. In some embodiments, the system is associated with a prescription service, such as a service where drivers can pay at different levels for different levels of service. In some embodiments, a first level of service allows users to join one or more standard virtual train, such as a virtual train that utilizes standard and/or non-optimum routes, allows users to share attentiveness requirements, allows the user to suggest changes (such as changes to route, speed, spacing, arrival time, departing time, or the like), allows a user to suggest whether another user can join the virtual train, or the like. In some embodiments, a second level of service allows users to join one or more prioritized virtual train, such as a virtual train that utilizes optimized routes or the like. In some embodiments, one or more level of service and/or one or more purchasable option allows users to dictate one or more factor associated with a virtual train, such as the amount of time the user is required to be attentive (if at all), routes, timing, speed, spacing, or the like. In some embodiments, routes and/or one or more other factor is determined by a third party, such as a government entity, corporate entity, driver of a different virtual train, passenger of a different virtual train, or the like. In some embodiments, one or more route or other determination is based on weather, construction, traffic, emergency, or the like.

In some methods a first driver driving a first vehicle watches for hazards while a second driver of a second vehicle is distracted. In some methods, the system and/or the first driver provides the second driver with an indication that one or more condition or circumstance is outside of the system's and/or the first driver's realm of experience and/or comfort level. In some methods, the system and/or the first driver provides the second driver (and/or a driver of one or more other vehicle associated with the first vehicle) with an indication that the first driver is or will be distracted and/or otherwise unable to watch for hazards, such as prior to the first driver disassociating from the second driver and/or other drivers (i.e. by leaving a virtual train).

In some embodiments, the system is configured to coordinate ground transportation with air transportation, such as air transportation within airspace positioned directly above one or more associated roadway. In some embodiments, the system is configured to optimize traffic flow capacity, such as by directing vertical spacing (i.e. airplanes, hovercrafts, and the like) along with lateral (adjacent lanes) and longitudinal (following distances) spacing. In some embodiments, the system is configured to direct hybrid vehicles (such as vehicles capable of ground and air transportation) to move from a ground-based mode to an air-based mode so as to maximize capacity of a roadway during an instance of high-volume traffic. In some embodiments, the system is configured to direct hybrid vehicles to move from an air-based mode to a ground-based mode, such as during poor weather conditions, low traffic volume, or the like.

In some embodiments, the system is configured to reduce traffic bottlenecks in general, such as by providing uniform flow into and out of bottleneck areas, by redirecting traffic flow during peak bottleneck events, by directing hybrid vehicles to convert modes, as necessary, thereby creating vertical stacking of vehicles so as to reduce bottlenecking, or the like. In some embodiments, the system includes one or more feature for reducing traffic issues (such as bottlenecking) for certain vehicles, such as government vehicles, emergency vehicles, and/or for personal vehicles under circumstances where expedited traffic flow is necessary or desired, such as by allowing individuals to pay for prioritized passageway through one or more bottleneck or other area.

Various embodiments of the present invention comprise:
more than one vehicle, vehicle guidance system, vehicle telemetry system, vehicle communication system communicating with another vehicle;
more than one vehicle communicating with another vehicle for purposes beyond collision avoidance;
more than one vehicle broadcasting current location and intended route of travel;
more than one vehicle broadcast being received by more than one other vehicle and/or centralized data processing center;
more than one vehicle announcing intentions of travel routing with intentions of cooping vehicular information;
more than one vehicle and/or centralized data processing center receiving information of common and/or coincident vehicular travel plans;
more than one vehicle utilizing information from one or more other vehicles and/or central data processing center to calculate best course of coincident travel;
more than one vehicle utilizing information from one or more other vehicle and/or central data processing center to coop information of all or part of possible routes travel;
more than one vehicle utilizing information of possible common travel to best interface with one another's travel and/or travel of all vehicles during any period of time, proposed and/or current;
more than one vehicle benefitting from cooped travel information that allows an ordering of all similar vehicle intentions and outcomes;
more than one vehicle developing coincident segment data of total travel for purposes of ‘training’ (ordered closest aggregation of proximity);
more than one vehicle adopting directed-autonomy for purposes of continuous streaming of data necessary for coincident travel;
more than one vehicle benefitting from directed-autonomy to best utilize the same highways and byways of travel in a manner of training;
more than one vehicle using directed-autonomy information of another vehicle and/or central data processing center and/or additional information sources to simultaneously and/or sequentially travel one or more routing segments together;
more than one vehicle using directed-autonomy for ‘hook-up’ at any time during coincident routing segments of travel in time and space;
more than one vehicle using directed-autonomy to remain ‘hooked-up’ in a manner of ‘training’ for purposes of economy of space, time and/or energy of all;
more than one vehicle using directed-autonomy to ‘un'hook’ from ‘training’ to fulfill independent destination arrival and/or other travel intentions;
more than one vehicle using directed-autonomy to employ all available methods of situational and mechanical systems awareness, such as telemetry, navigation, collision avoidance, vehicular performance, weather, etc. in pursuit of directed-autonomy;
more than one vehicle coupling and/or uncoupling from directed-autonomy ‘training’ to achieve individual travel requirements.
more than one type of vehicle, capable of identical and/or similar performance and mission utilizing directed-autonomy method and system (i.e. car, van, truck, taxi, limo, bus);
more than one type of vehicle capable of modifying its performance to complete the same directed-autonomy mission by virtue of onboard equipment and/or central data processing enablement;
more than one central data processing center dedicated to distant common directed-autonomy missions of the moment via direct and/or re-directed means of communications;
more than one vehicle benefitting from directed-autonomy economies of time, space and/or energy;
more than one highway/byway/arrival-departure establishment and/or owner/custodian thereof benefitting from directed-autonomy methods and means;
more than one vehicle reducing chance of collision by means of directed-autonomy method; and/or
more than one vehicle improving time and/or efficiency of travel by means of directed-autonomy method.

In some embodiments, the present invention comprises:
more than one onboard vehicular system communicating with an on-board directed-autonomy device, for purposes of collaborative with one or more other vehicles of similar or same equipment configurations;
more than one vehicle being able to identify, address and communicate with other vehicles with directed-autonomy intentions, independently and/or through central data processing center(s);
more than one central data processing center capable of directed-autonomy method collaborating with one another and/or more than one vehicle;
more than one ‘data point’ of arrival and departure being shared via a directed-autonomy system for reason and benefit of common/coincident travel segments of more than one vehicle;
more than one ‘decision point’ of hook-up, training and un-hooking considered by more than one vehicle, whether or not involved with any specific training ‘contract’;
more than one ‘contract’ of hookup, training, un-hooking possible in any given time period and/or travel segment of directed-autonomy; and
more than one vehicle hooking-up, training, unhooking, re-hooking-up for reasons periodic needs of the individual vehicle (i.e. intermediate unanticipated need, such as fuel, weather accommodation, special needs of vehicle driver or vehicle occupants, etc.).

In some embodiments, the present invention comprises:
more than one periodic central data processing center intra-system and/or exo-system ‘check’ for reasons of data/system/performance, system-updates and/or calibrations; and
more than one periodic vehicular intra-system and/or eco system as assigned or periodically required.

In various embodiments of the instant invention, a computer program of a central management system for a website and/or software applications is located on a central server connected via a communications network to various computing devices of system users. In some embodiments, the computing devices of system users are mobile computing devices, such as a smart phone that communicates with the central management system via an app installed on the device.

In some embodiments of the invention, in which the users utilize a smart phone app, tablet, pc or other personal computing device (collectively referred to herein as an “app”) for connecting with the central management system, the user has the option of using the app, or sharing data, etc. with the app to other systems and/or devices. In some embodiments, the app requires stores login credentials for the user.

Various embodiments of the computer program, devices, systems, and methods of the present invention are implemented in hardware, software, firmware, or combinations thereof using central management system of the invention, which broadly comprises server devices, computing devices, a communications network, and a membership ID (account number, etc.). Various embodiments of the server devices include computing devices that provide access to one or more general computing resources, such as Internet services, electronic mail services, data transfer services, and the like. In some embodiments the server devices also provides access to a database that stores information and data, with such information and data including, without limitation, system user information (e.g. ID, account number, etc.), or the like, or other information and data necessary and/or desirable for the implementation of the computer program, devices, systems, and methods of the present invention.

Various embodiments of the server devices and the computing devices include any device, component, or equipment with a processing element and associated memory elements. In some embodiments the processing element implements operating systems, and in some such embodiments is capable of executing the computer program, which is also generally known as instructions, commands, software code, executables, applications (apps), and the like. In some embodiments the processing element includes processors, microprocessors, microcontrollers, field programmable gate arrays, and the like, or combinations thereof. In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard disk drives, network attached storage, or a separate storage network.

Various embodiments of the computing devices specifically include mobile communication devices (including wireless devices), work stations, desktop computers, laptop computers, palmtop computers, tablet computers, portable digital assistants (PDA), smart phones, wearable devices and the like, or combinations thereof. Various embodiments of the computing devices also include voice communication devices, such as cell phones or landline phones. In some preferred embodiments, the computing device has an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional preferred embodiments, the computing device includes an optical device such as a digital camera, video camera, optical scanner, or the like, such that the computing device can capture, store, and transmit digital images and/or videos, bar codes or other identification information.

In some embodiments the computing devices includes a user control interface that enables one or more users to share information and commands with the computing devices or server devices. In some embodiments, the user interface facilitates interaction through the GUI described above or, in other embodiments comprises one or more functionable inputs such as buttons, keyboard, switches, scrolls wheels, voice recognition elements such as a microphone, pointing devices such as mice, touchpads, tracking balls, styluses. Embodiments of the user control interface also include a speaker for providing audible instructions and feedback. Further, embodiments of the user control interface comprise wired or wireless data transfer elements, such as a communication component, removable memory, data transceivers, and/or transmitters, to enable the user and/or other computing devices to remotely interface with the computing device.

In various embodiments the communications network is wired, wireless, and/or a combination thereof, and in various embodiments includes servers, routers, switches, wireless receivers and transmitters, and the like, as well as electrically conductive cables or optical cables. In various embodiments the communications network includes local, metro, and/or wide area networks, including the Internet and/or other cloud networks. Furthermore, some embodiments of the communications network include cellular and/or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network is wired, wireless, and/or a combination thereof. Thus, in some such embodiments, the server devices and the computing devices include components to establish a wired and/or a wireless connection.

Various embodiments of the computer program of the present invention run on computing devices. In other embodiments the computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices as well. For example, in some embodiments information is stored on a memory element associated with the server device, such that the information is remotely accessible to users of the computer program via one or more computing devices. Alternatively, in other embodiments the information is directly stored on the memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using the computer program are performed by one or more computers, processors, or other computational devices, such as the computing devices and/or server devices, independently or cooperatively executing portions of the computer program.

Various embodiments of the present invention are accessible to one or more user via one or more electronic resource, such as an application, a mobile “app,” or a website. In certain embodiments, portions of the computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. Some embodiments of the web-accessible computer program are configured to allow a user to simply access the computer program via the network (e.g., the Internet) with the computing device.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A vehicle transportation system comprising:
a means of communicating between a first group of vehicles; and
a means of determining a common route for each vehicle of the first group of vehicles, such common route being utilized for creating a first virtual train consisting of the first group of vehicles.

2. The vehicle transportation system of claim 1, wherein the common route forms a first portion of a total route for a first vehicle of the first group of vehicles.

3. The vehicle transportation system of claim 2, wherein the first vehicle is directed when to join the first virtual train and when to exit the first virtual train.

4. The vehicle transportation system of claim 3, wherein the system is configured to receive a first suggestion from the first vehicle, the suggestion being one of:
a suggestion to change speed;
a suggestion to change vehicle spacing;
a suggestion to change one or more aspect of the common route;
a suggestion to expel a vehicle from the first virtual train; and
a suggestion associated with whether an additional vehicle should be added to the first virtual train.

5. The vehicle transportation system of claim 4, wherein the system is configured to allow at least some of the vehicles of the first virtual train to vote on whether or not to implement the first suggestion.

6. The vehicle transportation system of claim 4, wherein the system is configured to determine relative priority of each vehicle of the first virtual train and to implement the first suggestion in the event priority of the first vehicle is greater than priority of the other vehicles.

7. The vehicle transportation system of claim 6, wherein the first vehicle has priority over the other vehicles of the first virtual train when each of the other vehicles is a passenger vehicle having a standard subscription and the first vehicle is one of:
a government vehicle;
an emergency vehicle;
a passenger vehicle having a premiums subscription; and
a passenger vehicle having a standard subscription but for which a fee was paid in association with the first suggestion.

8. The vehicle transportation system of claim 3, wherein the first vehicle is directed to join a second virtual train after exiting the first virtual train, the second virtual train being associated with a second portion of the total route of the first vehicle.

9. The vehicle transportation system of claim 3, wherein at least two vehicles of the first virtual train form a third virtual train upon the first vehicle exiting the first virtual train.

10. The vehicle transportation system of claim 3, wherein the system is configured to receive a first request from a vehicle outside of the first virtual train, the first request being one of:
a request to join the first virtual train;
a request for the first virtual train to increase spacing so as to allow for other vehicles to merge between vehicles of the first virtual train; and
a request to merge a second virtual train with the first virtual train for a common route.

11. An infrastructure optimization system comprising:
a means of communicating between a first group of vehicles; and
a means of optimizing flow of the first group of vehicles through a first portion of the infrastructure.

12. The infrastructure optimization system of claim 11, wherein the means of optimizing flow comprises minimizing spacing between adjacent vehicles while maintaining safe following distances for each vehicle.

13. The infrastructure optimization system of claim 12, wherein each vehicle of the first group of vehicles is directed to follow a specific pathway associated with the first portion of the infrastructure, the specific pathway comprising at least one of:
a lane of a roadway; and
airspace above a roadway.

14. The infrastructure optimization system of claim 13, wherein the system is configured to direct vehicles to move from a ground-mode to an air-mode so as to facilitate movement from a roadway surface to airspace above the roadway surface, thereby facilitating vertical stacking of traffic.

15. The infrastructure optimization system of claim 14, wherein the system is configured to cause vehicles to reduce longitudinal spacing between a first and third vehicle upon a second vehicle moving from a ground-mode to an air-mode, thereby increasing traffic capacity in association with vertical stacking of traffic.

16. The infrastructure optimization system of claim 14, wherein the system is configured to cause vehicles to increase longitudinal spacing between a first and third vehicle so as to facilitate a second vehicle moving from an air-mode to a ground-mode.

17. The infrastructure optimization of claim 12, wherein the system is configured to direct a first vehicle to change positions relative to the second position in association with relative braking capabilities, thereby facilitating increased capacity by decreasing spacing requirements.

18. The infrastructure optimization of claim 12, wherein the system is configured to direct a first vehicle to move away from a second vehicle due to cargo in each vehicle creating an increased risk of harm or damage to people or property in the event the vehicles collide, thereby increasing overall safety.

19. The infrastructure optimization of claim 12, wherein the system is configured to direct a first vehicle to move out of the way of a second vehicle, wherein the second vehicle has priority over the first vehicle.

20. The infrastructure optimization system of claim 19, wherein the first vehicle is a passenger vehicle having a standard subscription and the second vehicle is one of:
a government vehicle;
an emergency vehicle;
a passenger vehicle having a premiums subscription; and
a passenger vehicle having a standard subscription but for which a fee was paid in association with obtaining priority over the first vehicle.
